(19) United States
(12) Patent Application Publication
(10) Pub. No.: US 2020/0331814 A1
(43) Pub. Date: Oct. 22, 2020

(54) SEALING AND CURING CEMENTITIOUS MATERIALS

(71) Applicant: TRADEMARK NITROGEN CORP., Tampa, FL (US)

(72) Inventors: Mike Barry, Tampa, FL (US); Stephen E. Novak, Fernandina Beach, FL (US); Matthew Parsons-Cohrs, Tampa, FL (US)

(21) Appl. No.: 16/842,236

(22) Filed: Apr. 7, 2020

Related U.S. Application Data
(60) Provisional application No. 62/836,186, filed on Apr. 19, 2019.

(51) Int. Cl. C04B 40/02; C04B 41/00; C04B 41/48; C04B 41/49; C04B 41/50

(52) U.S. Cl. CPC C04B 40/02; C04B 41/009; B28B 11/245; C04B 41/49; C04B 41/5007; C04B 41/4842

(57) ABSTRACT

Disclosed are methods and solutions for sealing and curing concrete and other cementitious materials using strontium containing, non-alkali, non-silica, chemical solutions. The strontium-based solutions can be placed in admixture with cementitious materials prior to molding and curing to create a final product, or the strontium-based solutions can be applied to newly created or existing cementitious material surfaces to improve the repellent and stain, resistant properties.

### TECHNICAL FIELD AND BACKGROUND

The present invention relates generally to sealing cementitious materials, and more particularly, to methods and solutions for sealing concrete and other cementitious materials using strontium containing, inorganic, non-alkali, non-silica, chemical solutions.

Conventional sealants and curing agents for cementitious materials include organic-based solutions (“OBS” or “organic sealants”) and inorganic, alkali-metal-silicate solutions (“AMSS” or “alkali sealants”). Conventional organic sealants currently available on the market that include silicon-based compounds, epoxies, and acrylics dry to form a surface membrane protective layer on the surface of the cementitious material to prevent moisture from penetrating the material. Alkali sealants on the other hand, work by penetrating the cementitious material surface and reacting with calcium and silica in the cementitious material to form calcium silicate hydrate (“C—S—H”), which reduces the cementitious material porosity and increases the strength of the material both at and below the surface. Both organic sealants and alkali sealants have certain disadvantages with regard to safety, durability, aesthetics, ease of use, and other factors.

Organic sealants may contain volatile organic compounds that are harmful to the environment and potentially hazardous to individuals applying the sealant to a cementitious surface. Additionally, organic sealants should be applied only after the cementitious material has fully cured because the impervious protective layer created by the sealants may interfere with the hydration process that occurs during curing. Organic sealants may also be incompatible with many adhesives or surface coatings, such as paints and stains, and the sealant itself may turn yellow over time when exposed to ultraviolet light. The protective layer is also prone to degradation over time leaving the underlying surface exposed to wear from unwanted elements if the sealant is not reapplied.

Like organic sealants, alkali sealants generally should not be applied until after the cementitious material is fully cured as the sealants interfere with hydration, and alkali sealants are known to be hazardous to individuals applying the sealants. Alkali sealants are also corrosive to metal and surrounding fixtures and structures that should be protected or removed prior to application. Following application, alkali sealants tend to promote efflorescence that results in a dusty, white coating that must be removed prior to use of the cementitious material, installation of flooring (e.g., tile, carpet, wood paneling, etc.), or application of paint, stain, or other coatings. Excess alkali ions in alkali sealants can also lead to alkali-silica reaction (“ASR”) effects that result in cracking and structural deformities in the cementitious materials. Finally, alkali sealants are expensive and known to have a relatively short shelf life of about one-year and cannot be stored in extreme temperatures outside of approximately forty to ninety degrees Fahrenheit.

Considering the numerous drawbacks of existing sealants for cementitious materials, it would be desirable to provide sealants that are safe, durable, easy to use, and that do not interfere with the curing process. It is, therefore, an object of the present invention to provide methods for sealing cementitious materials using strontium-based chemical solutions that incorporate into the cementitious material crystalline matrix and react with the cementitious material to reduce porosity and improve strength and durability. It is a further object of the invention to provide sealing methods and strontium-based sealants that are safe, cost competitive, non-corrosive, that do not react with other coatings, and that do not interfere with the curing process so that such sealants can be applied to newly created as well as existing cementious material surfaces.

### BRIEF DESCRIPTION OF THE FIGURES

Features, aspects, and advantages of the present invention are better understood when the following detailed description of the invention is read with reference to the accompanying figures, in which:

FIGS. 1A and 1B depict application of a sealant to a cementitious surface.

FIG. 2A is an optical microscope image of a cement mixture.

FIG. 2B is an optical microscope image of a cement mixture that includes a strontium solution.

FIG. 3A depicts cement test specimens without a strontium solution during molding.

FIG. 3B depicts cement test specimens without a strontium solution after molding.

FIG. 4A depicts cement test specimens that includes a strontium solution during molding.

FIG. 4B depicts cement test specimens that includes a strontium solution after molding.

FIG. 5A is a gradation curve of fine aggregate.

FIG. 5B is a gradation curve of coarse aggregate.

FIG. 6A shows absorption test results for mortar specimens with a 3 day cure time.

FIG. 6B shows absorption test results for mortar specimens with a 7 day cure time.

FIG. 6C shows absorption test results for mortar specimens with a 28 day cure time.

FIG. 7A shows absorption test results for concrete specimens with a 3 day cure time.

FIG. 7B shows absorption test results for concrete specimens with a 7 day cure time.

FIG. 7C shows absorption test results for concrete specimens with a 28 day cure time.

FIG. 8 illustrates a compressive strength testing setup.

FIG. 9 shows compressive strength testing results.

FIG. 10A illustrates an abrasion resistance testing setup.

FIG. 10B illustrates a front view of a cutter head used for abrasion resistance testing.

FIG. 10C illustrates a perspective, side view of a cutter head used for abrasion resistance testing.

FIG. 11A shows abrasion resistance test results for mortar specimens with a 3 day cure time.

FIG. 11B shows abrasion resistance test results for mortar specimens with a 7 day cure time.

FIG. 11C shows abrasion resistance test results for mortar specimens with a 28 day cure time.

FIG. 12A shows abrasion resistance test results for concrete specimens with a 3 day cure time.

FIG. 12B shows abrasion resistance test results for concrete specimens with a 7 day cure time.

FIG. 12C shows abrasion resistance test results for concrete specimens with a 28 day cure time.

FIG. 13 illustrates a water retention test setup.

FIG. 14 shows water retention test results.

FIG. 15 shows abrasion resistance test results for concrete specimen treated with different sealants and sealants with varying strontium nitrate concentration.

FIG. 16 shows results for early application abrasion resistance testing.

FIG. 17 illustrates a X-Ray diffraction analysis.

FIG. 18A illustrates a Scanning Electron Microscope image of a hydrated cement sample.

FIG. 18B illustrates a Scanning Electron Microscope image of a hydrated cement sample treated with 30% strontium nitrate sealant solution.

FIG. 19 depicts setting time test results for strontium nitrate in admixture with cement paste.

FIG. 20 illustrates compressive strength testing for strontium nitrate in admixture with cement paste.

### DETAILED DESCRIPTION

The present invention will now be described more fully hereinafter with reference to the accompanying pictures in which exemplary embodiments of the invention are shown. However, the invention may be embodied in many different forms and should not be construed as limited to the representative embodiments set forth herein. The exemplary embodiments are provided so that this disclosure will be both thorough and complete and will fully convey the scope of the invention and enable one of ordinary skill in the art to make, use, and practice the invention.

Relative terms such as lower or bottom; upper or top; upward, outward, or downward; forward or backward; and vertical or horizontal may be used herein to describe one element's relationship to another element illustrated in the figures. It will be understood that relative terms are intended to encompass different orientations in addition to the orientation depicted in the drawings. Relative terminology, such as “substantially” or “about,” describe the specified materials, steps, parameters, or ranges as well as those that do not materially affect the basic and novel characteristics of the claimed inventions as whole (as would be appreciated by one of ordinary skill in the art).

Disclosed are methods for sealing cementitious materials utilizing strontium-based chemical solutions. The embodiments described herein are generally described with reference to strontium nitrate based solutions, which are preferred solutions, but those of skill in the art will appreciate that other strontium compounds can be used, including, for example, strontium chloride, strontium acetate, strontium bromide, strontium carbonate, strontium hydroxide or strontium oxide, as well as combinations of these compounds. The strontium compound concentration in a sealant solution should generally be between 3 and 45 percent.

Strontium sealants and curing agents may optionally include other compounds directed to enhancing water or oil repellent and stain resistant properties when applied to cementitious materials, including, but not limited to, silanes, siloxanes, and/or other silicon-based additives. The strontium sealants and curing agents can further include components directed to improving the penetration of the sealant into the cementitious material, such as ionic and/or non-ionic surfactants. Other examples of additives and components that can be used with strontium sealants include, but are not limited to, surfactants, leveling agents, and pigments. Such additives can be mixed with the strontium sealant solution or can be applied to the cementitious material before or after application of the sealant. The process may be repeated multiple times as necessary.

It is generally understood that cement, such as ordinary portland cement that serves as a binder in concrete, is formed from a series of reactions starting with calcium hydroxide (Ca(OH)2) and silicic acid (H4SiO4). Silicic acid is formed when an alkali hydroxide solution, such as NaOH or KOH, dissolves amorphous silica (SiO2). The calcium hydroxide and silicic acid react to produce water and various calcium silicate compounds, including tricalcium silicate (Ca3SiO5) and dicalcium silicate (Ca2SiO5). Concrete is formed when the calcium silicate compounds are hydrolyzed to form calcium silicate hydrate (“C—S—H”) gel, water, carbon dioxide and heat characterized by the following exemplary reaction formula: 2Ca₃SiO₅+7H₂O→3CaO.2SiO₂.4H₂O+3Ca(OH)₂(Energy). As the C—S—H gel hardens, it exhibits a degree of crystallinity and is the major product contributing to the overall strength increase of the hydrated cement concrete. Without added water, the reaction slows over time and can require a typical cure time of around thirty (30) days.

Alkali sealants react in much the same way by reacting and complexing with unreacted calcium and silica in the concrete to form additional C—S—H within the pores and capillaries of the existing concrete material. The additional C—S—H formation reduces porosity and increases the strength of the concrete at and below the surface, thereby increasing resistance to the penetration of corrosive and degrading substances while also providing more abrasion resistance.

Alkali solutions, however, suffer from the drawbacks discussed above, including high-cost, corrosiveness, efflorescence, ASR effects, storage and shelf-life limitations, and potential health hazards to individuals applying the sealant. Efflorescence occurs when the alkali component drives unreacted calcium to the surface where it reacts with carbon dioxide in the atmosphere to create the dusty, white coating that must be removed, ASR effects become a concern when excess alkali ions in the sealant form a viscous, hygroscopic gel of sodium silicate (Na2H2SiO4) that is also referred to as sodium silicate hydrate. The gel swells and increases in volume as it absorbs water, which exerts internal pressure in the concrete that causes cracks, spalling, and shifting within the concrete material.

Strontium sealants react using a similar mechanism to alkali sealants but do not suffer from the same drawbacks. The sealing mechanism of strontium sealants can be better understood with reference to the following simplified example involving strontium nitrate. The following example, as well as other embodiments disclosed herein, is generally described with reference to sealing concrete surfaces, but those of ordinary skill in the art will appreciate that the methods and solutions are effective for sealing other cementitious materials as well.

Strontium nitrate is a white crystalline solid in powder form that is composed of strontium and nitrate ions having the formula Sr(NO3)2. Strontium nitrate is typically generated by the reaction of nitric acid on strontium carbonate represented by the following exemplary reaction formula: 2HNO₃+SrCO₃→Sr(NO₃)₂+H₂O+CO₂.

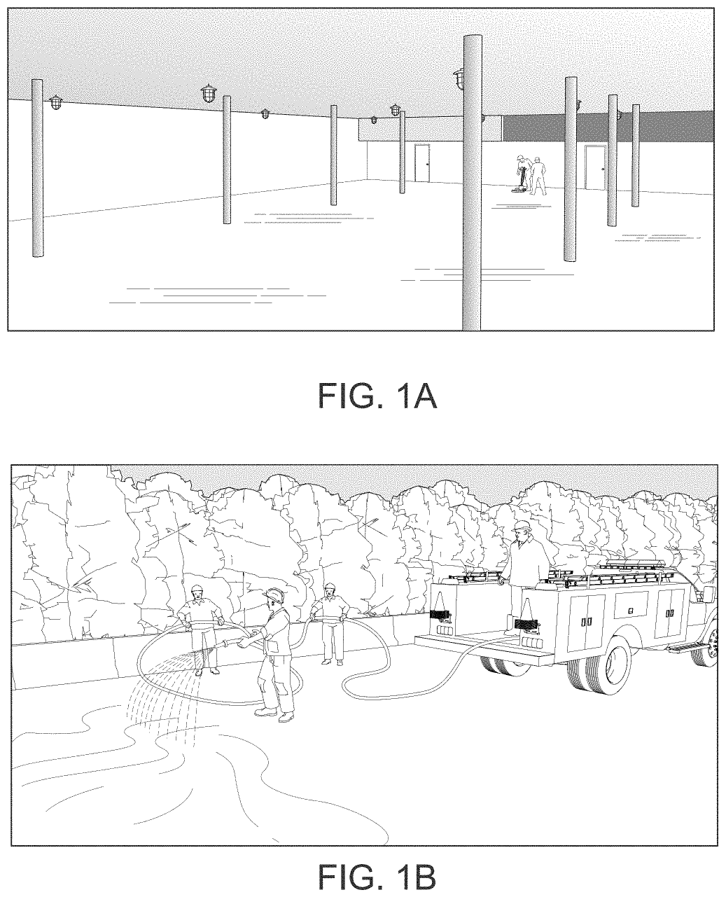

The strontium nitrate is placed in solution to create a sealant. The sealant is applied to the surface of a cementitious material. Unlike organic or alkali sealants, strontium sealants can be applied to newly formed concrete without impacting the curing process. The strontium sealant can be applied by spraying, mopping, rolling, painting or otherwise applying the liquid strontium sealant to the target surface. FIG. 1A illustrates application of the sealant to an indoor surface using an industrial floor cleaning machine while FIG. 1B illustrates spraying the sealant onto an outdoor surface. The strontium sealant is suitable for application to newly poured or existing concrete or other cementitious materials that include, but are not limited to, pavers, panels, cement blocks, conduits, and other structural materials.

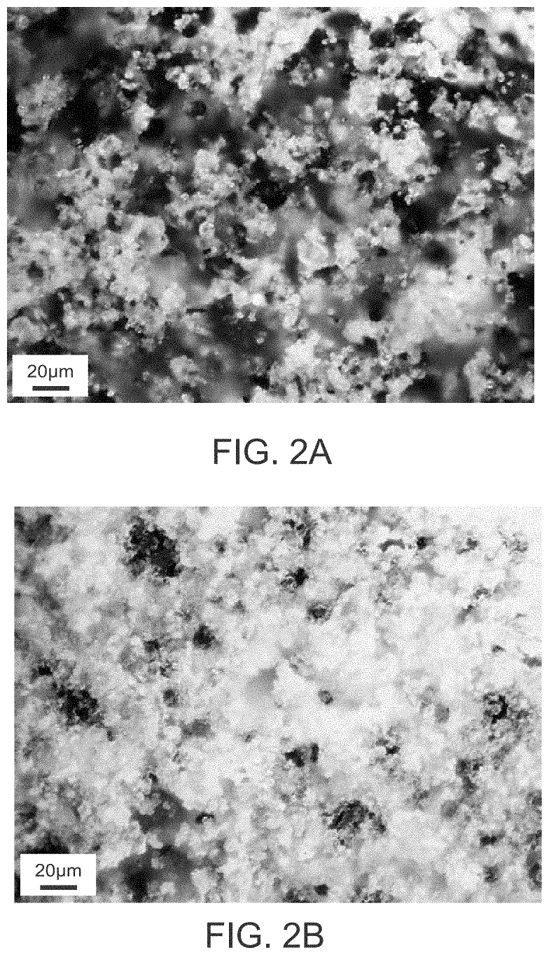

Following application of the strontium sealant to the, target material, free hydroxide (OH) ions dissolve silicate in the material to produce soluble silicic acid. The nitrate ion (NO3) disassociates from the strontium nitrate (Sr(NO3)2) in the presence of hydroxide ions to produce strontium hydroxide (Sr(OH)2). The strontium hydroxide reacts with silicic acid to produce strontium silicate compounds that include strontium silica hydrate (“Sr—S—H”), strontium calcium silica hydrate (“Sr—C—S—H”), and strontium aluminum silica hydrate (“Sr—Al—S—H”), as well as combinations thereof. Compared to C—S—H, the crystal structures built around the strontium molecule are stronger, and more completely fill voids and capillaries thus explaining the much improved water resistant properties and hardness. This effect is illustrated in FIGS. 2A and 2B, which are optical microscope images obtained from the cement paste described in the below working example that were taken without (FIG. 2A) and with (FIG. 2B) an added 37% strontium nitrate solution. The mixture including the strontium nitrate solution (FIG. 2B) presents a denser appearance and more white-colored components owing to the reaction of the strontium nitrate with the cement components to produce hydrated products in the mixture.

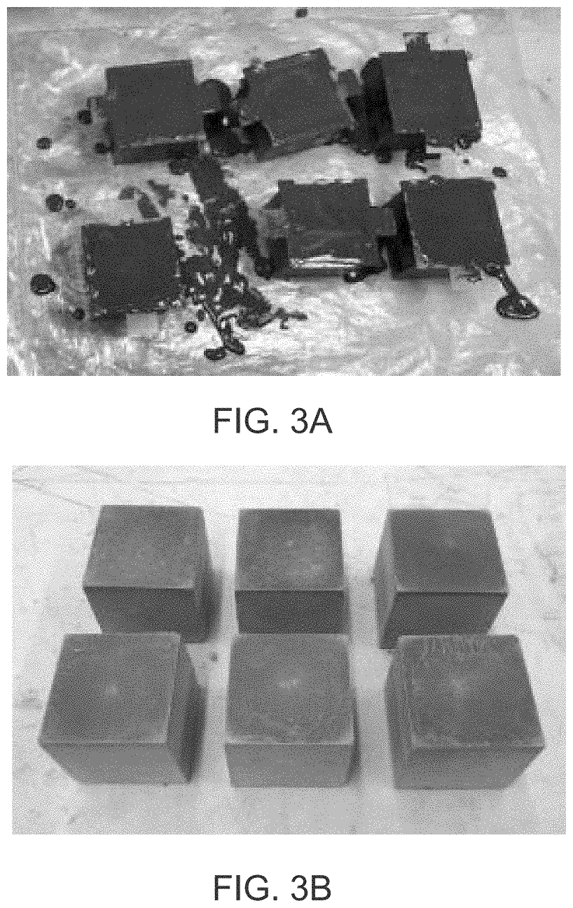

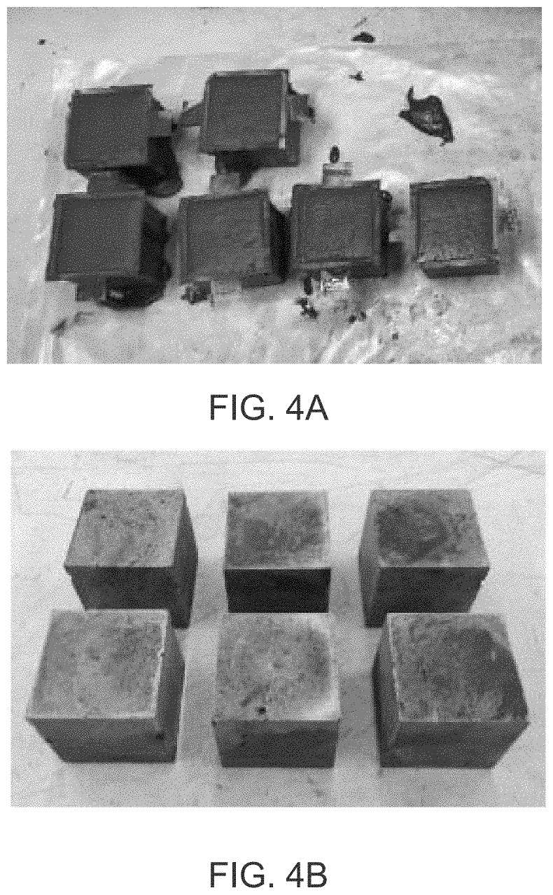

In addition to sealant solutions that can be applied to the surface of a cementitious material, strontium nitrate compounds can also be utilized as an admixture for directly mixing with cement paste prior to forming or molding the cement paste and permitting it to cure into a final product. The results of including strontium nitrate in the cement paste are illustrated in FIGS. 3A, 3B, 4A, and 4B. A cement mixture including 37% strontium nitrate solution was used to form 2×2×2 inch cube specimens that were compared against cube specimens molded without the strontium nitrate. FIGS. 3A and 3B depict the cube specimens formed without the strontium nitrate solution, which show significant bleeding that was not observed in the cube specimen shown in FIGS. 4A and 4B formed with strontium nitrate.

The use of strontium sealants demonstrates several advantages over existing organic and alkali sealants. Strontium sealants not only reduce the surface porosity like organic sealants, but strontium sealants also penetrate the concrete material surface and react with the material to create strontium silicate compounds integrated with the material structure. In this manner, strontium sealants provide a denser, less porous layer of concrete up to a quarter of an inch thick. The reactions with strontium sealants are faster than conventional reactions involving organic or alkali sealants leading improved material properties (e.g., less absorption, stronger, increased abrasion resistance) with less cure time.

Strontium sealants and curing agents also control water vapor emission from the concrete to facilitate the hydration process, thereby allowing C—S—H byproduct gas emissions such as CO2 to occur as needed during hydration. Because strontium sealants do not interfere with curing, the sealants can be applied to newly placed or existing concrete surfaces. Strontium sealants provide long-term protection from concrete degradation by militating against the intrusion of degrading substances such as water, chlorides, acids, alkalis, and organics into the concrete material. Strontium sealants do not contain or emit volatile organic compounds, and the sealants are non-toxic and non-hazardous while also being colorless and odorless. Moreover, strontium sealants are cost competitive and do not promote ASR as do existing alkali sealants.

The strontium sealants can be used with organosilicon based additives, fluoropolymer additives, or blends of such additives, which further promote moisture repellency and absorption resistance. Additives include, hut are not limited to, silicone derivatives such as silanes and siloxanes that penetrate into the cementitious materials and react with compounds in the cementitious materials to form hydrophobic resins that allow gases to escape during the curing process while repelling water intrusion from the outside surface upon drying. Silane-, siloxane-, and fluoropolymer-based additives provide long-term, durable water repellent properties owing to their incorporation within the cementitious material matrix crystalline lattice as opposed to forming a temporary membrane on the surface of a cementitious material. Such additives and blends thereof are included within a strontium-based sealant at concentrations between 0.5% and 50% by weight and preferably between 1% to 10% by weight.

Silane-based water repaints penetrate into the cementitious material substrate and react with calcium hydroxide to form a hydrophobic, water repellent resin within pores of the material. Silanes are generally compounds with four substituents on a silicon atom, such as organosilicon compounds. Examples of organosilicon silane compounds include trichlorosilane (SiHCl3), tetramethylsilane (Si(CH3)4), tetraethoxysilane (Si(OC2H5)4), and methyl trimethyoxysilane ((CH3)Si(O3CH3)3). Silanes tend to have small molecular sizes making silane-based repellents well suited for use in dense cementitious materials, like concrete. The small molecular size allows silane repellent compounds to penetrate deeper into the cementitious material matrix than other types of repellents.

Alkoxy and Alkyl silanes are typical silane derivatives that are used as hydrophobic water repellents, and Alkoxy and Alkyl silanes include compounds having silicon bonded to one or more hydrocarbons and bonded to one or more oxygen atoms where the oxygen atoms are themselves bonded to hydrocarbon compounds. In one exemplary embodiment, the silane compound utilized as a water repelling additives is alkoxysilane. Effective silane additive concentrations within a strontium-based sealant solution can range from ______ to 0.5% to 25% by weight and preferably from 1% to 10%.

Siloxane compounds are characterized by the siloxane functional group having the O—S—O bond linkage as the backbone of the material. Siloxane-based repellents function by penetrating into the cementitious material to form a cross-linked silicone resinous material. Siloxanes tend to have larger molecular sizes relative to silanes and do not penetrate as deep into a cementitious material matrix but provide better surface coverage rates. Siloxane-based repellent compounds are, therefore, better suited for porous cementitious materials, such as masonry, grout, stone, or mortar. Siloxane-based repellents can be used in combination with silane-based repellents to provide better coverage rates and deeper penetration.

Siloxanes react with atmospheric moisture as well as moisture in the cementitious material substrate to form a hydrophobic resin. Specific examples of siloxane compounds suitable for water repelling additives include, Polydimethylsiloxane (“PDMS”) and Polymethylhydrogensiloxane (“PMHS”). As a consequence of the larger molecular sizes, siloxane repellent compounds are generally used in smaller concentrations than silanes (e.g., 5% to 15% by weight). Siloxane-based repellent concentrations within a strontium-based sealant solution can range from 0.25% to 10% and preferably from 0.5 to 5%.

Fluoropolymer-based repellent additives are characterized by organic polymer molecules to which fluorine atoms are appended. Fluoropolymers, such as polytetrafluoroethylene, also penetrate the cementitious material substrate and react with the cementitious material to form hydrophobic compounds that permit moisture to escape while offering water repellent properties. The fluoropolymer molecules are generally small (even nanosized) such that they are easily incorporated into the pores of a cementitious material. Fluoropolymer materials are known for having strong carbon-fluorine bonds that are stable and nonreactive. These bonds are more durable, long lasting, UV resistant, and heat resistant than silanes, siloxanes, and siliconates. Fluorinated sealants can offer the advantage of being both water and oil resistant. Fluoropolymer additives can additionally include polyethylene terephthalate (polyester) or high-density polyethylene (“HDPE”) that improve the durability and water repellent property of the additive. Fluoropolymer additive concentrations within a strontium-based sealant solution can range from 0.25% to 10% and preferably from 0.5 to 5%.

In yet other embodiments, the strontium sealants can include organic additives that provide an initial, short-term harrier to water evaporation. The evaporation barrier additive can be placed in admixture with the strontium sealant solution or can be applied separately to the surface of a cementitious material. The evaporation barrier additive may remain on the surface of the cementitious material for a few days (e.g., between 3 to 7 days while the concrete cures and then be conveniently removed through sweeping or washing. In some cases, the evaporation barrier may break down and dissipate once the cementitious material has cured.

Non-limiting examples of evaporation barrier additives include waxes, such as paraffin, polyethylene, or a scale wax. As one example, paraffin wax is added at about 30% to 60% by weight as a short-term moisture sealant. The evaporation barrier additive can also be an oil or oil-based curing compound, such as a polyvinyl alcohol compound, chlorinated rubber curing compounds, resin based curing compounds, and other materials and compounds that will form a temporary membrane or film over a cementitious material. Another embodiment of temporary moisture sealing agent includes water--soluble film-forming polymers, such as polyvinylpyrrolidone or the like. Other materials that may be used as short-term sealants include, but are not limited to, chloroparaffins, fatty acid triglycerides, alkyl sulfonic esters (e.g., phenols, cresoles, fatty acid esters, etc.), phthalates (e.g., dioctyl phthalate, dibutyl phthalate, benzyl butyl phthalate, etc.), polymers derived from glycerol, polymers derived from iso-cyanates or thio-cyanates (e.g., polyurethane, vegetable oil-extended polyurethane systems, moisture-curable polyurethane polymers, etc.), and polymers derived from sulfur-containing reactants.

The improved cementitious material properties are illustrated by the following working examples and experimental test results.

### Phase I Experimental Test Results

The phase 1 testing utilized normal portland cement concrete and cement mortar specimens as test samples. The specimen surfaces were treated with strontium nitrate solution. For comparison purposes, two other silicate-based sealants were used. The laboratory tests included absorption tests, compressive strength tests, surface abrasion resistance tests, and water retention testing.

### Materials and Specimens

The phase 1 testing utilized a 37% by weight strontium nitrate sealant solution. The strontium nitrate solution was compared against two commercially available silicate-based solutions: (1) 42% a sodium silicate (Na₂SiO₃) based sealant; and (2) a 23% lithium silicate (Li—₂SiO₃) based sealant. The two commercial solutions were diluted by 3 parts water according to the product instructions: that is, the product-to-water ratio was 1:3 by volume.

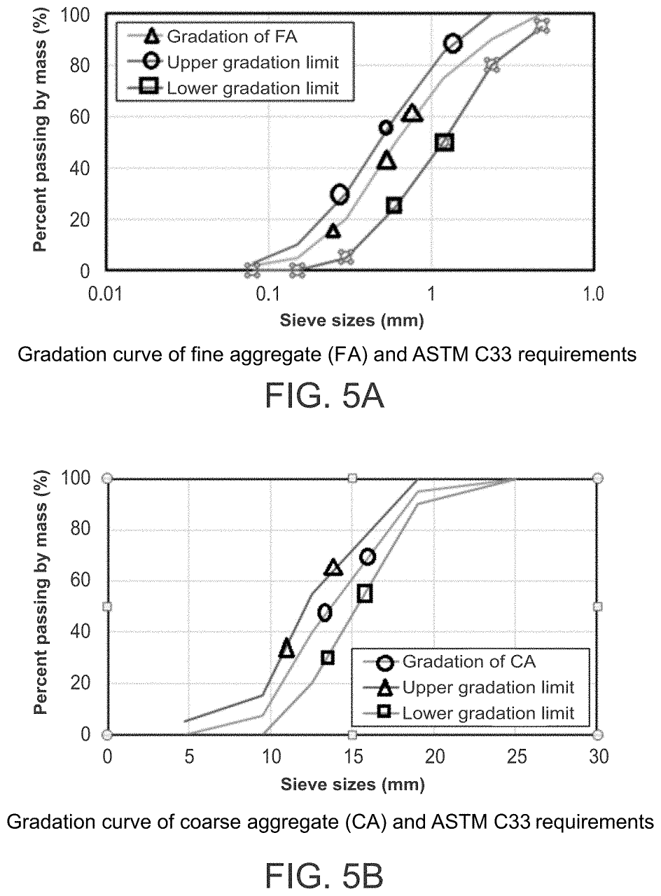

Test specimens were composed of either normal portland cement concrete or mortar, which used type I ordinary portland cement (“OPC”) as a binder. For an aggregate, the specimens used standard sand as a fine aggregate (“FA”) and graded granite as a coarse aggregate (“CA”). The OPC followed ASTM standard C150, and the FA and CA followed the ASTM standard C33. The chemical composition of the OOC used for testing is listed below in Table 1. The gradation curves of FA and CA are illustrated in the attached FIGS. 5A and 5B along with the upper and lower limits required by ASTM C33.

TABLE 1
Chemical composition of OPC

| Component | CaO | SiO₂ | Al₂O₃ | Fe₂O₃ | SO₃ | IR | LOI |
|---|---|---|---|---|---|---|---|
| % | 64.90 | 21.49 | 4.21 | 3.50 | 0.70 | 1.10 | — |

Test specimen were formed as disks or cubes and demolded after 24 hours curing time at room temperature (72° F.) and a relative humidity of 40%. The demolded specimens were wet cured in water bath for 28 days. After 28 days of wet curing, all specimens were fully dried in an environmental chamber to stop the cement hydration process. Therefore, it could be assumed that all specimens were prepared as fully hydrated and stabilized with no more chemical reaction conditions.

Next, the finished specimens were coated with a sealant and left for cure periods of 3, 7, and 28 days. For all cases, control specimens, having a 28 day cure period with no application of any surface treatment were prepared to compare test results and identify effects of the three different types of sealants. The control specimens were stored at normal room temperature and relative humidity environmental conditions.

The mix proportions of cement concrete and mortar mixtures used in the testing are summarized below in Table 2. The water-to-cement ratio was 0.5 for all mixtures. Disk type specimens having 4-inch diameter and 2-inch height were prepared for the water absorption test and the surface abrasion resistance test. For the compressive strength test, 2×2×2 inch cube specimens were molded using cement mortar mixture.

TABLE 2
Mix proportion and IDs

| | Cement | | Fine Aggregate | Coarse Aggregate |
|---|---|---|---|---|
| Mixture | (kg/m³) | W/C | (kg/m³) | (kg/m³) |
| Mortar | 580 | 0.5 | 1,450 | — |
| Concrete | 384 | 0.5 | 801 | 881 |

### Water Absorption Testing

For the water absorption testing, all surfaces of the specimens were sealed with a latex resin to control moisture movement during testing with the exception of one flat surface that was exposed to water. Any pinholes that remained after the latex hardened were eliminated by applying additional latex resin. The three types of sealants (lithium silicate, sodium silicate, and strontium nitrate) were applied to the exposed surface of the specimens using a brush pre-wetted with the sealant. The specimens were cured in normal room temperature and relative humidity conditions for 3, 7, and 28 days.

The amount of water absorption through the surface of cement mortar and concrete specimens coated by different types of sealants was measured in accordance with ASTM C1585 standards. Support aluminum rods were placed on a plastic tray, and the tray was filled with water 1 to 3 mm above the top of supporting rods. Initial weights of the specimens were recorded for calculation of water absorption. The weight change of the specimens resulting from the absorption of water was measured as a function of time up to 10 days.

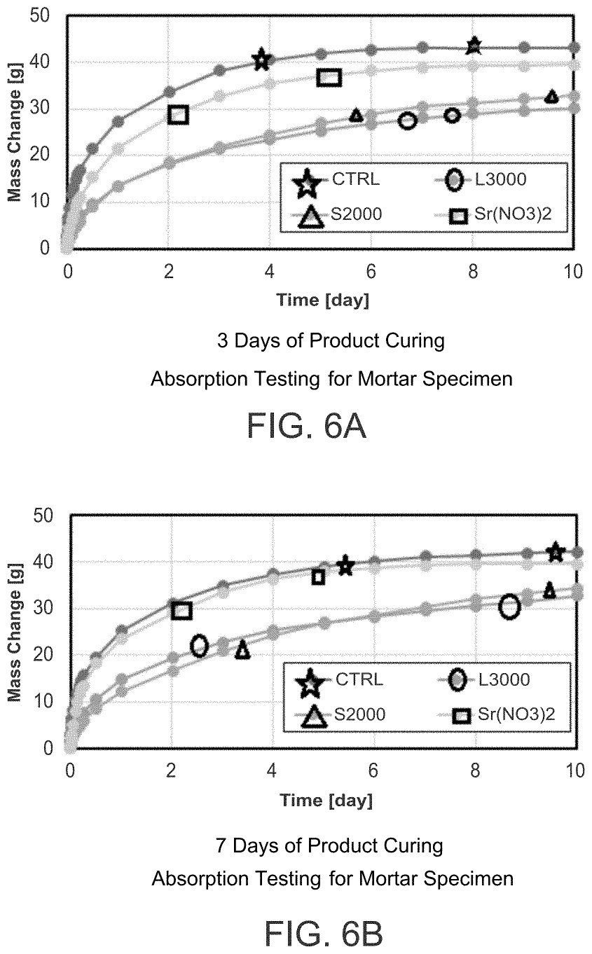

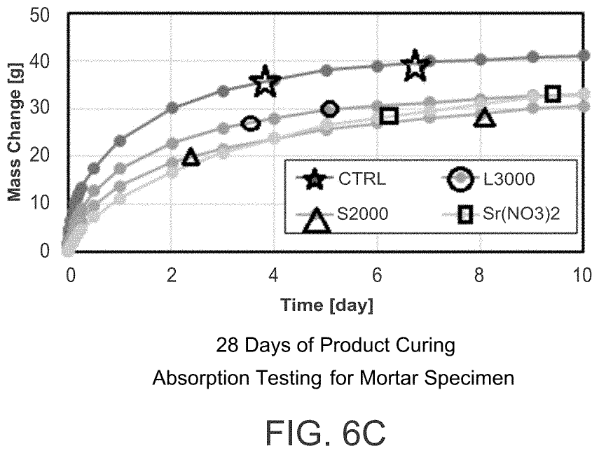

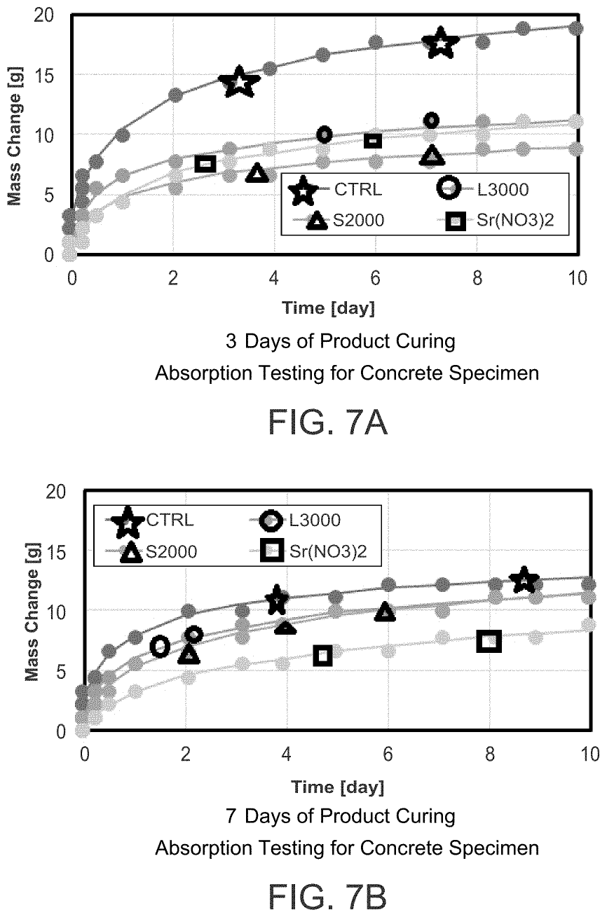

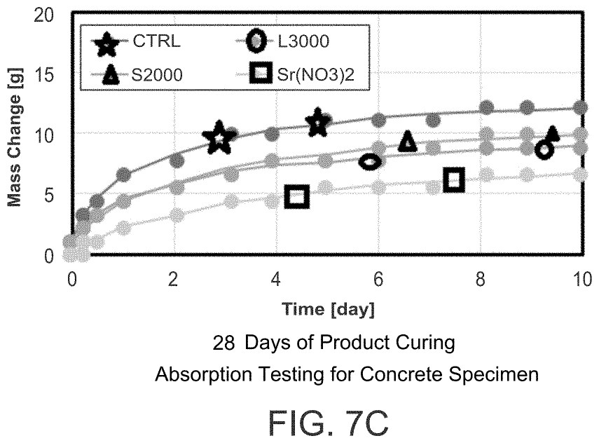

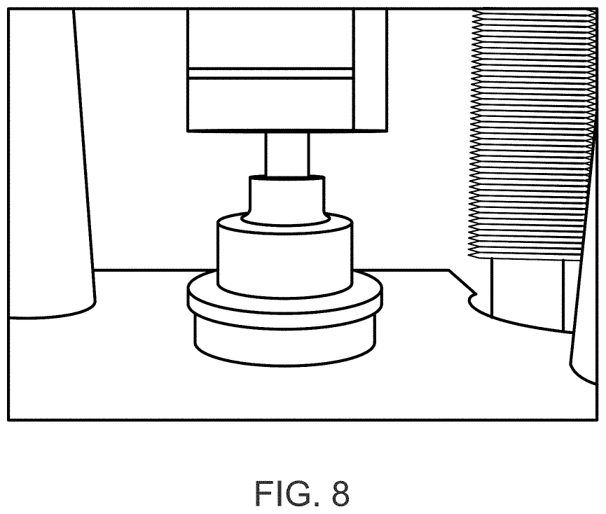

FIGS. 6A-6C and FIGS. 7A-7C show the results of water absorption test for mortar (FIG. 6) and concrete specimens (FIG. 7) for the 3, 7, and 28 day cured specimens for the different types of sealants. For the 28 day cured mortar specimen, strontium nitrate solution demonstrates similar performance in comparison with the lithium silicate and sodium silicate sealants. For the 3 and 7 day cured specimens, the strontium nitrate solution presented lower level of performance than the silicate-based sealants.

In the concrete specimens, the strontium nitrate solution recorded the best results for both the 7 and 28 day cured specimens and shows similar results for the 3 day cured specimens as compared to the lithium silicate and sodium silicate sealants.

### Compressive Strength Testing

The 28 day cured cement mortar cube specimens were soaked in the three different types of sealants for 6 hours. Then the specimens were stored at room temperature and at relative humidity conditions for 3, 7, and 28 days for curing.

Compressive strength tests were carried out on the cube mortar specimens coated by the three different sealants (lithium silicate, sodium silicate, and strontium nitrate) in accordance with ASTM C109 standards. FIG. 8 shows the setup for compressive strength testing. The testing was conducted at a loading rate of 900 N/sec on the specimens. The peak load was recorded and divided by the cross-sectional area of the cube specimen to calculate the maximum compressive strength.

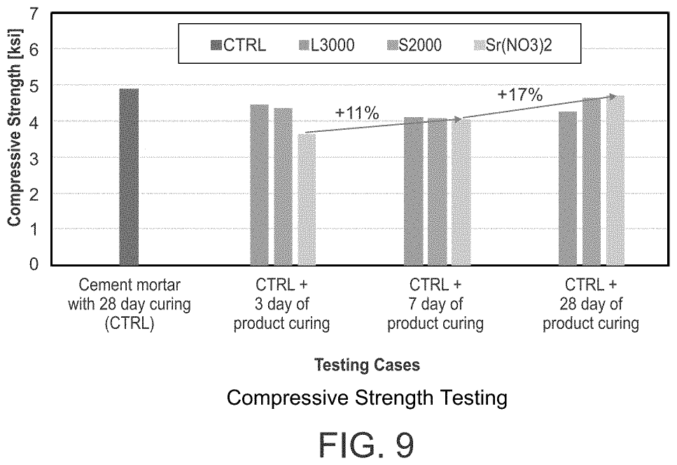

FIG. 9 shows the results of compressive strength testing for the cement mortar cube specimens coated by the different types of sealants and cured for 3, 7, and 28 days after the sealant application. For the 28 day cured specimens, the samples coated by strontium nitrate solution demonstrated the best performance. The samples cured for 3 and 7 days presented lower levels of compressive strength in comparison with the lithium silicate and sodium silicate sealants. For the strontium nitrate treated samples, it is apparent that the strength increased as the curing time increased. The compressive strength increased about 11% from 3 days to 7 days of curing. In addition, a 17% improvement was observed from 7 days to 28 days of curing for the strontium nitrate solution specimens.

### Abrasion Resistance Testing

The sealants were applied to the top, flat surface of the 28 day cured disk-shaped specimens for conducting the surface abrasion resistance testing. Pursuant to the commercial sealant product instructions, 1.5 ml of each sealant (including strontium nitrate) was applied to the surface of each specimen using a brush that was pre-wetted with the sealants.

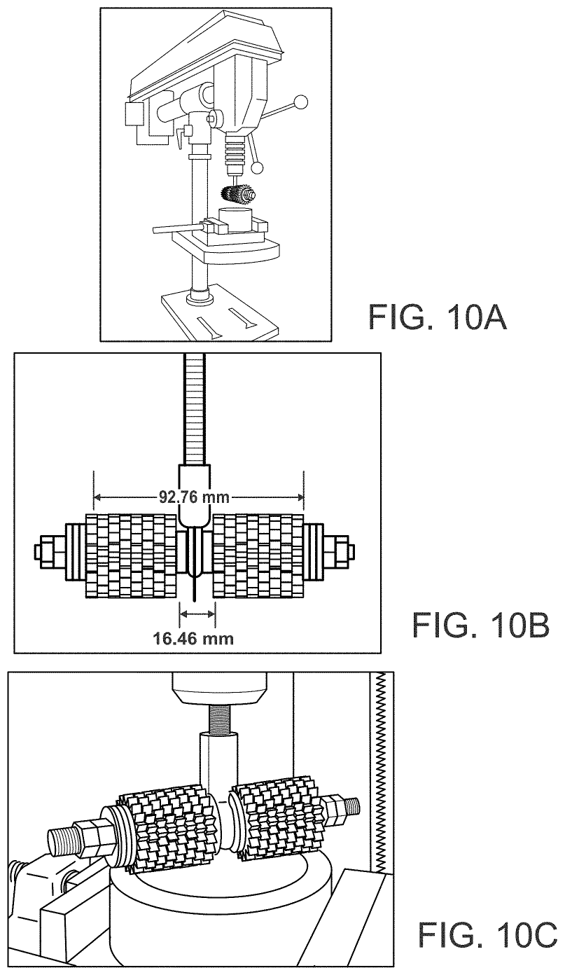

Surface abrasion resistance tests on the disk-shaped of cement concrete and mortar specimens were performed according to ASTM C944 standards. FIGS. 10A to 10C illustrate the device setup and rotating cutter head used for abrasion testing. The rotating cutter head stayed in contact to the top surface of specimens using 22 pounds of force and rotated at a rate of 200 rpm. The testing ran for 1 minute, and the weights (mass) of the specimens were measured repeatedly up to 6 minutes. Thus, the abrasion resistance performance of each specimen was determined by measuring mass loss in grams.

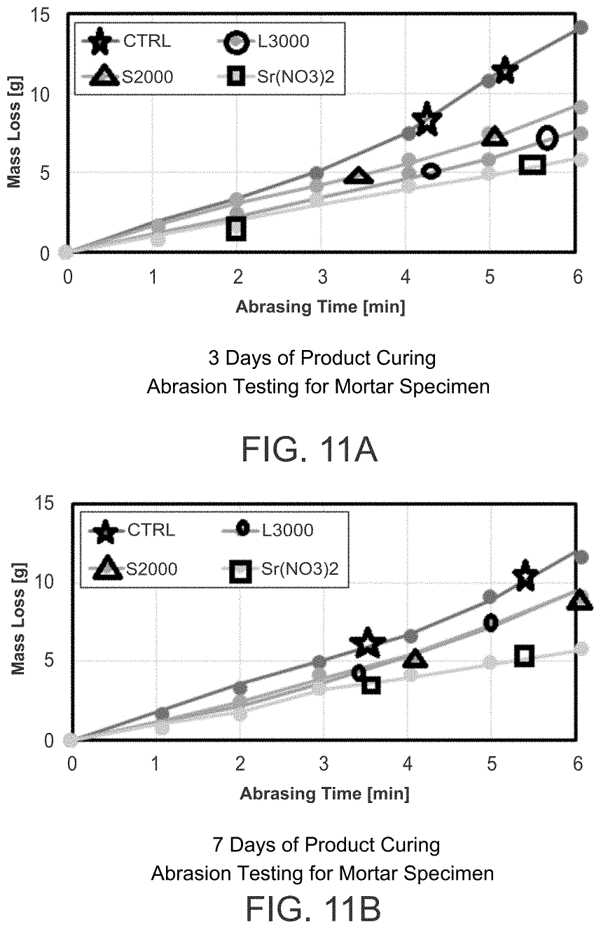

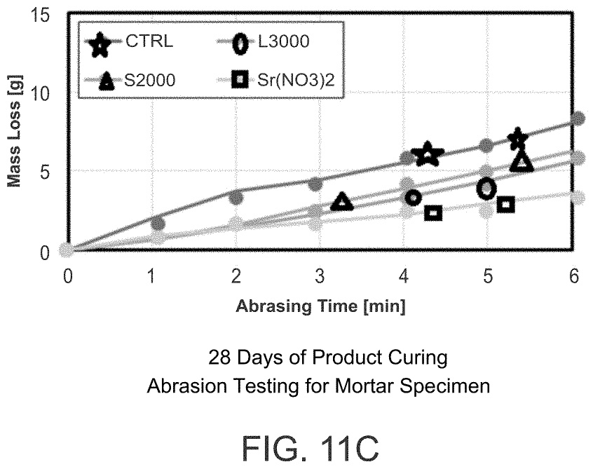

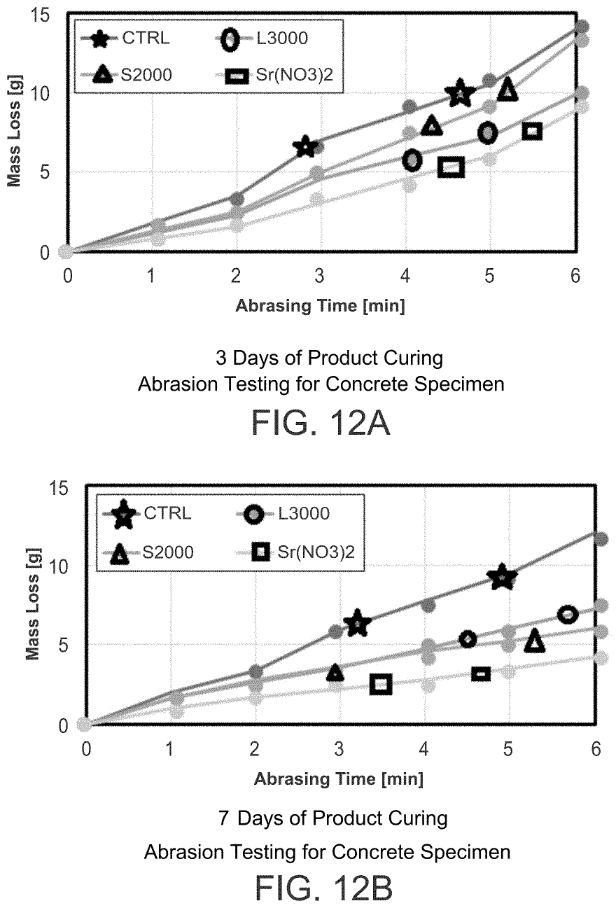

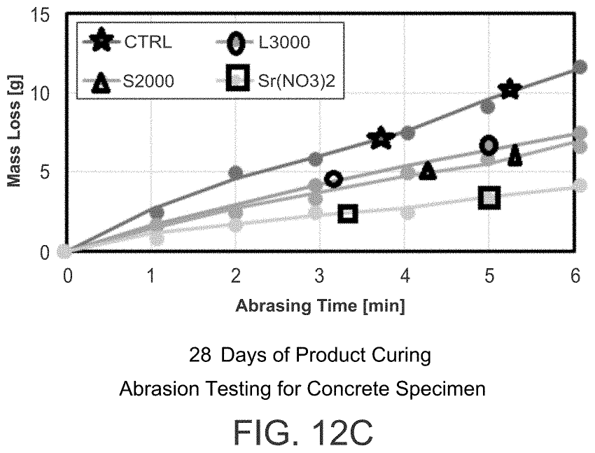

FIGS. 11A-C and 12A-C show the results of the surface abrasion resistance testing for the mortar specimens (FIG. 11) and concrete specimens (FIG. 12) respectfully for the three different curing periods. For all cases, the strontium nitrate solution demonstrated the best performance for both the cement mortar and concrete specimens, which correlates to the smallest amount of measured weight loss after testing. The control specimens without any sealants resulted in the worst performance for both the mortar and concrete specimens. The positive effect of strontium nitrate solution was apparent at the early stages of curing. In other words, the strontium nitrate solution provided the best performance and fastest effect on both the mortar and concrete mixtures.

### Water Retention Testing

The ability of a cementitious material to retain water vapor during curing helps control the hydration process to enhance curing. Water retention testing was performed to measure the effects of the strontium nitrate sealant on the evaporation of water as compared to control specimen. Testing was performed according to modified ASTM C156 standards at a concrete temperature of 25° C., an ambient air temperature of 22° C., a relative humidity of 45%, and a wind velocity of 11.0 kilometers per hour (km/hr). The calculated evaporation rate at these conditions is approximately 0.57 kilograms per meter squared per hour (kg/m2/hr).

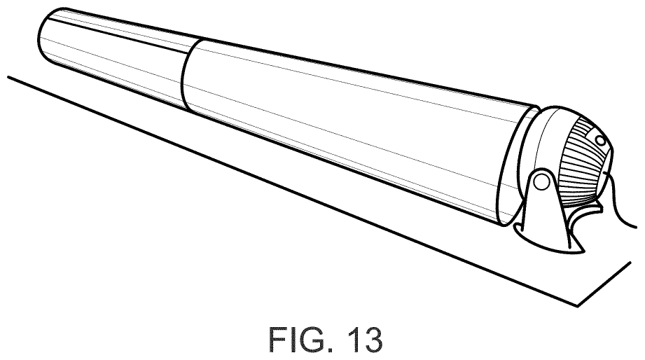

Disc-shaped control specimens were prepared along with disc-shaped test specimens that were treated by spraying the specimen with a 30% strontium nitrate solution. The specimens were tested by placing them in a wind tunnel with airflow generated by a fan at one end of the tunnel. The test setup is depicted in FIG. 13.

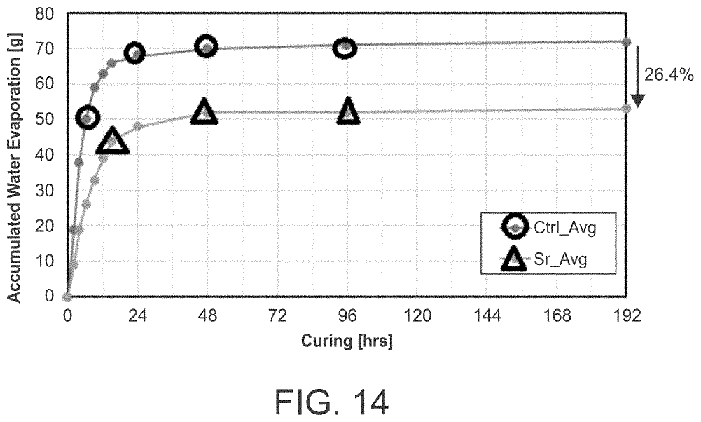

The test specimens treated with strontium nitrate shown a decreased rate of water evaporation at the early stages of the curing period up to nine hours after pouring the concrete. Overall, the strontium nitrate specimens showed a reduced accumulated water evaporation of about 26.4% for 8 days (192 hours as compared to the control specimens. The test data is shown below in Table 3 as well as the attached FIG. 14.

TABLE 3
Water Retention Test Results

| | Control (C) | Sr(NO₃)₂ (SR) | Difference | Ratio |
|---|---|---|---|---|
| Curing Hours | [kg/m²/hr] | [kg/m²/hr] | (C − SR) | (C/SR) |
| 0-2 | 0.521 | 0.247 | 0.274 | 0.47 |
| 2-4 | 0.521 | 0.274 | 0.247 | 0.53 |
| 4-6 | 0.329 | 0.192 | 0.137 | 0.58 |
| 6-9 | 0.164 | 0.128 | 0.037 | 0.78 |
| 9-12 | 0.073 | 0.110 | −0.037 | 1.50 |
| 12-15 | 0.055 | 0.091 | −0.037 | 1.67 |
| 15-24 | 0.012 | 0.024 | −0.012 | 2.00 |
| 24-48 | 0.005 | 0.007 | −0.002 | 1.50 |

### Phase 2 Experimental Test Results

A second phase of testing was performed to evaluate an optimum strontium nitrate concentration for abrasion resistance and to evaluate the use of strontium nitrate sealant solution as an early application agent. The strontium nitrate solutions were again compared against commercially available sodium silicate based and lithium silicate based sealant solutions.

The test specimens were made from concrete with type 0.1 OPC as a binder. For aggregate, the specimens used standard sand as a fine aggregate and graded granite as a coarse aggregate. The OPC followed ASTM standard C150, and the FA and CA followed the ASTM standard C33. The chemical composition of the OPC used for testing is listed above in Table 1. Control specimens having a 28 day cure period with no application of any surface treatment were prepared to compare test results and identify effects of the various types of sealants tested. The control specimens were stored at normal room temperature and relative humidity environmental conditions.

### Optimum Concentration Abrasion Resistance Testing

Optimum concentration abrasion resistance testing was performed using multiple strontium nitrate sealant solutions having 5%, 10%, 20%, and 30% by weight strontium nitrate. Test specimens were formed as disks demolded after 24 hours curing time at room temperature (72° F.) and a relative humidity of 40%. The demolded specimens were wet cured in water bath for 28 days. After 28 days of wet curing, all specimens were fully dried in an environmental chamber to stop the cement hydration process. Therefore, it could be assumed that all specimens were prepared as fully hydrated and stabilized with no more chemical reaction conditions. The specimens were then coated with the sealant solutions prior to abrasion testing.

The abrasion resistance testing was performed according to ASTM C944 standards. The test apparatus used for abrasion testing is shown in FIGS. 10A to 10C. The rotating cutter head stayed in contact to the top surface of specimens using 22 pounds of force and rotated at a rate of 200 rpm. Each test specimen was subject to abrasion for 6 minutes as per determined by ASTM standard 944, and the weights (mass) of the specimens were measured. Thus, the abrasion resistance performance of each specimen was determined by measuring mass loss in grams. Testing was performed at curing periods of 31 days, 35 days, 42 days, and 56 days.

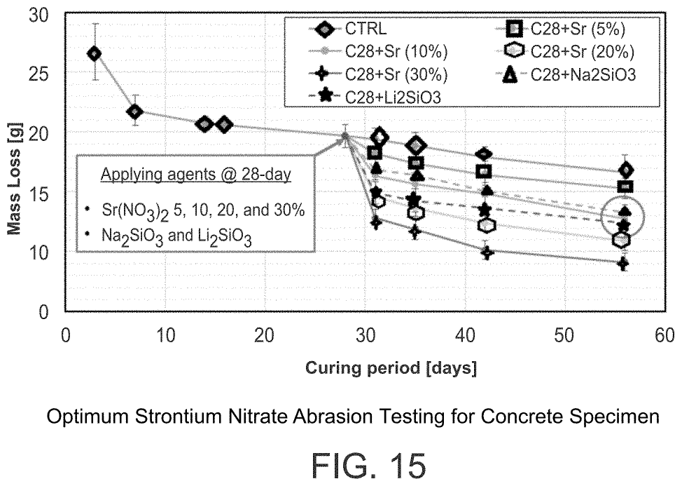

The results are show in in FIG. 15 and illustrate that abrasion resistance improved as the strontium nitrate concentration increased with the 20% strontium nitrate concentration performing better than both the sodium silicate based and lithium silicate based sealant solutions. The 30% strontium nitrate concentration specimen performed the best of all specimens tested.

### Early Application Abrasion Resistance Testing

The early application abrasion resistance testing was performed on concrete specimen coated with a 30% by weight strontium nitrate solution shortly after the specimens were poured. The test specimen were coated: (i) less than 2 hours after pouring (designated “AP”); (ii) at the plastic setting stage, 5 hours after pouring, also referred to as initial set (designated “IS”); and (iii) after hardening at 10 hours after pouring, also referred to as final set (designated “FS”). These set times were determined by ASTM standard C-191. The abrasion resistance testing was performed according to ASTM standard 944.

The abrasion resistance testing was performed at various points during the curing process at approximately 2 days, 8 days, 14 days, 28 days, and 56 days. The specimens treated with strontium nitrate based sealant were compared against a control specimen that was additional tested at 14 days, 31 days, 35 days, 42, and 56 days into the curing process.

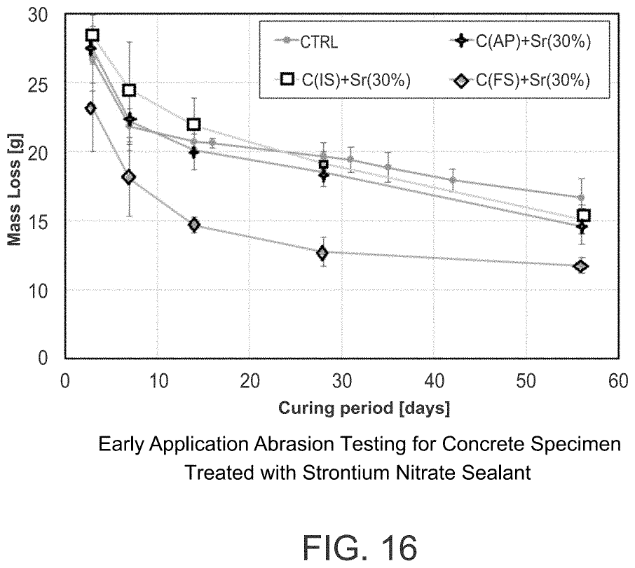

Results of the early application resistance testing are depicted in FIG. 16. There was no clear improvement over the control specimen for the specimens coated with strontium nitrate based sealant less than 2 hours (AP) and at 5 hours (IS) after setting. However, the specimen treated after hardening (FS) showed a significant improvement in abrasion resistance over the control sample.

The improvement in abrasion resistance for the sample treated 10 hours after setting is significant because for conventional sealants, manufacturers and other industry participants and experts recommend applying sealant after a significant curing time of at least 28 days. Applicant's test results, however, illustrate that strontium nitrate based sealants result in improved performance even when applied much earlier in the curing process at 10 hours after pouring contemporaneous with or shortly after concrete hardening.

### Scanning Electron Microscope and X-Ray Diffraction Results

Scanning Electron Microscope (“SEM”) and X-Ray Diffraction studies were performed on hydrated cement grain mixed with 30% strontium nitrate sealant solution that were cured for 1, 7, or 28 days. The test specimens were compared against a control specimen of cured hydrated cement that was not treated with a sealant and that had been cured for 28 days.

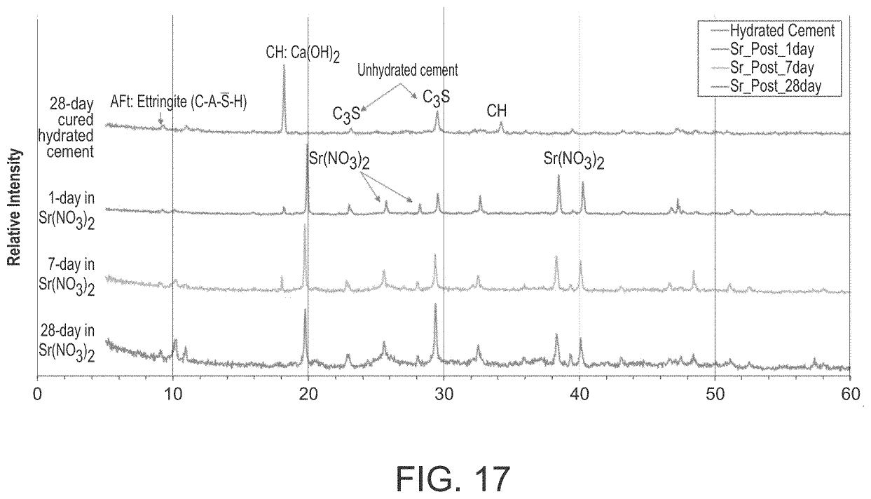

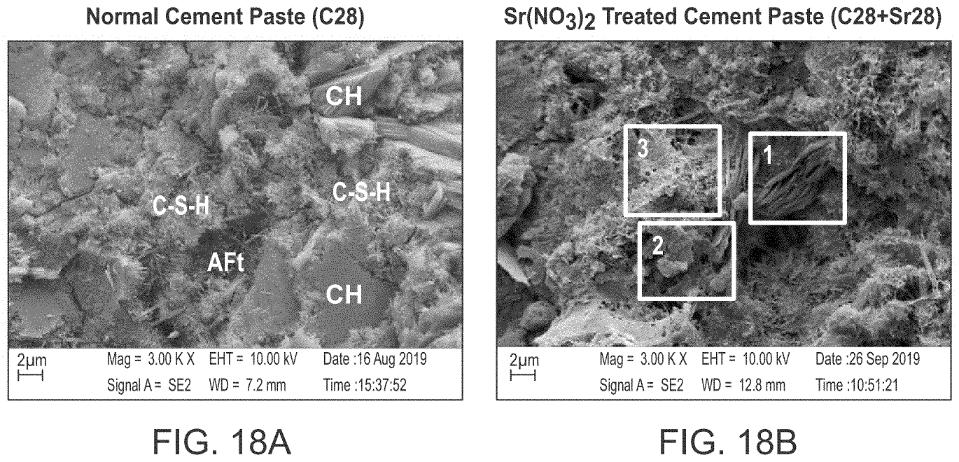

Results of the X-Ray Diffraction are shown in FIG. 17. As compared to the control specimen, the treated specimens showed a reduced calcium hydroxide (“CH”) content, which indicates an increase in the formation of calcium silicate hydrate (“C—S—H”) gel that exhibits crystallinity as it hardens and contributes to the overall strength of the concrete. This result is confirmed by the SEM images shown in FIGS. 18A and 18B that illustrate a reduced presence of CH regions in the resulting material.

### Initial and Final Setting Time Testing

The setting time was tested for cement paste samples mixed with either 1% or 2% strontium nitrate by weight as compared to a control sample. Setting time is the time required for stiffening of cement paste to a defined consistency—i.e., the time it takes for the cement paste to being losing plasticity. Initial setting time should be long enough to permit enough time for the cement paste to be placed in the desired mold and/or transported as needed but quick enough that the cement paste begins to attain the desired strength for usability and to conform to the desired mold. Final setting time it generally the time it takes for the cement paste to being losing its plasticity, harden, and take the form of the mold in which it is placed.

Setting time was measured using a Vicat's apparatus according to ASTM Standard C-191 by periodically observing impressions made in the cement paste by a needle at various times after water is added to commence the curing process. The Vicat initial time of setting is the time elapsed between the initial contact of cement and water and the time when the penetration is measured or calculated to be 25 mm. The heat final time of setting is the time elapsed between initial contact of cement and water and the time when the needle does not leave a complete circular impression in the paste surface.

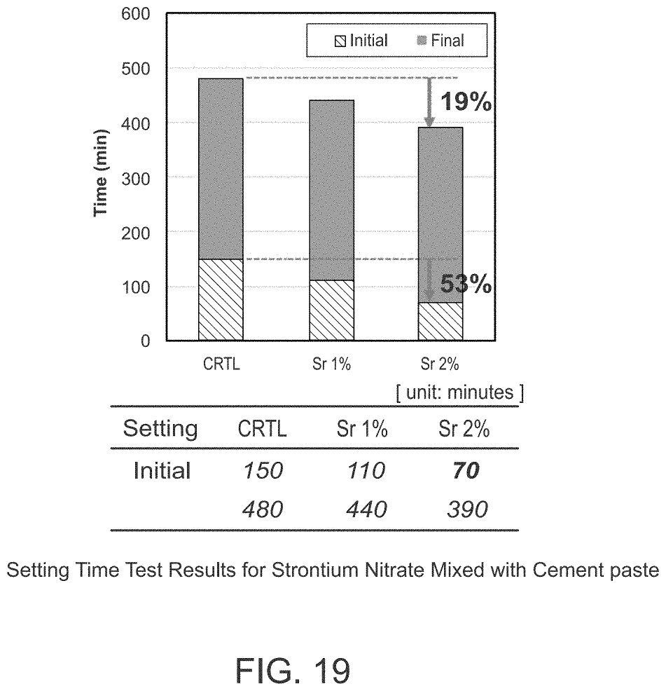

The results for the initial setting time testing are shown in FIG. 19 and illustrate that even the addition of 1% or 2% strontium nitrate by weight to the concrete paste result in shorter setting times as compared to the control sample. The addition of I% by weight strontium nitrate reduces both the initial and final setting times by about 40 minutes while the addition of 2% strontium nitrate reduces the initial and final setting times by 80 minutes and 90 minutes respectively, as compared to the control specimen. The faster setting times is in part further evidenced by increased exothermic nature of the reaction when strontium nitrate is added to the cement paste, which was observed during testing as increased temperatures and heat of hydration generated during at least the initial phase of curing. Consequently, strontium nitrate showed positive potential for use as an accelerator in the curing process as compared to control specimen.

### Compressive Strength Testing

Phase 2 compressive strength testing was performed on specimen with 30% strontium nitrate solution mixed in cement paste, which equated to 15% by weight of the cement paste. The specimens were stored at room temperature and at relative humidity conditions for 3, 7, and 28 days for curing. FIG. 8 shows the setup for compressive strength testing. The testing was conducted at a loading rate of 900 N/sec on the specimens. The peak load was recorded and divided by the cross-sectional area of the cube specimen to calculate the maximum compressive strength.

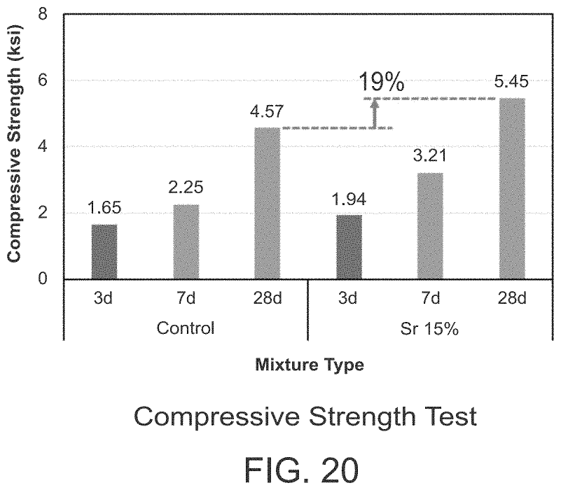

Results of the phase 2 compressive strength testing are shown in FIG. 20. Compressive strength was improved significantly for each of the 3, 7, and 28-day cured specimen. The 3 day-cured specimen shown an approximately 18% improvement, the 7-day cured specimen showed an approximately 43% improvement, and the 28-day cured specimen showed an approximately 19% improvement over the control specimen. Consequently, like the strontium nitrate sealant coatings, the addition of the strontium nitrate at relatively high concentrations in admixture with the cement paste also led to improved mechanical properties.

Although the foregoing description provides embodiments of the invention by way of example, it is envisioned that other embodiments may perform similar functions and/or achieve similar results. Any and all such equivalent embodiments and examples are within the scope of the present invention.

What is claimed is:

1. A method for sealing cementitious materials comprising:
(a) preparing a cementitious material mixture;
(b) arranging the cementitious material mixture into a desired structural configuration;
(c) applying a sealant solution to a surface of the cementitious material mixture, wherein the sealant solution comprises a curing agent selected from one or more of strontium nitrate, strontium chloride, strontium acetate, strontium bromide, strontium carbonate, strontium hydroxide or strontium oxide.

2. The method of claim 1, wherein the sealant solution comprises a strontium nitrate curing agent having a concentration between 3% to 45% by weight and preferably between 25% and 35% by weight.

3. The method of claim 1, wherein the sealant solution comprises a strontium nitrate curing agent having a concentration of at least 15% by weight.

4. The method of claim 1, wherein the sealant solution is applied to the cementitious material mixture between 5 hours and 24 hours after the cementitious material mixture begins to cure.

5. The method of claim 1, wherein the sealant solution is applied to the cementitious material mixture between 5 hours and 72 hours after the cementitious material mixture begins to cure.

6. The method of claim 1, wherein the sealant solution is applied to the cementitious material mixture between 5 hours and 28 days after the cementitious material mixture begins to cure.

7. The method of claim 1, wherein the sealant solution further comprises an additive selected from one or more of an organosilicon silane, a siloxane, or a fluoropolymer.

8. The method of claim 7, wherein the additive has a concentration between 0.5% and 50% by weight.

9. The method of claim 7, wherein the additive has a concentration between 1% and 10% by weight.

10. The method of claim 1, wherein the sealant solution further comprises an alkoxysilane organosilicon silane additive.

11. The method of claim 1, wherein the sealant solution further comprises a polydimethylsiloxane additive.

12. The method of claim 1, wherein the sealant solution further comprises C6 polymer urethane polyester fluoropolymer additive.

13. A method for sealing cementitious materials comprising:
(a) preparing a cementitious material mixture that includes a sealant, wherein
(i) the sealant comprises between 3% and 45% strontium salt, and wherein
(ii) the strontium salt is selected from one or more of strontium nitrate, strontium chloride, strontium acetate, strontium bromide, strontium carbonate, strontium hydroxide or strontium oxide; and
(b) arranging the cementitious material mixture into a desired structural configuration.

14. The method of claim 13, wherein the sealant solution is applied to the cementitious material mixture between 5 hours and 28 days alter the cementitious material mixture begins to cure.

15. The method of claim 14, wherein the sealant solution further comprises an additive selected from one or more of an organosilicon silane, a siloxane, or a fluoropolymer.

16. The method of claim 15, wherein the additive has a concentration between 0.5% and 50% by weight.

17. A method for introducing an additive to concrete surfaces and other cementitious materials comprising:
(a) creating an admixture by adding an additive to the concrete mixture before pouring the cement mixture into a desired configuration to form a structural configuration, wherein
(i) the admixture comprises between 3% and 45% by weight strontium salt, and wherein
(ii) the strontium salt is selected from at least one of strontium nitrate. strontium chloride, strontium acetate, strontium bromide, strontium carbonate, strontium hydroxide or strontium oxide.

18. A method for sealing cementitious materials comprising the step of applying a sealant solution to a surface of the cementitious material mixture, wherein the sealant solution comprises a curing agent selected from one or more of strontium nitrate, strontium chloride, strontium acetate, strontium bromide, strontium carbonate, strontium hydroxide or strontium oxide.

19. The method of claim 18, wherein the sealant solution comprises a strontium nitrate curing agent having a concentration of at least 15% by weight.

20. The method of claim 18, wherein the sealant solution comprises a strontium nitrate curing agent having a concentration between 25% and 45% by weight.

21. The method of claim 18, wherein the sealant further comprises a water repellent selected from at least one of an organosilicon silane, a siloxane, or a fluoropolymer.

22. A sealant for cementitious materials comprising:
(a) a curing agent that is between 3% and 45% by weight strontium salt, wherein the strontium salt is selected from one or more of strontium nitrate, strontium chloride, strontium acetate, strontium bromide, strontium carbonate, strontium hydroxide or strontium oxide; and
(b) a water repellent selected from at least one of an organosilicon silane, a siloxane, or a fluoropolymer.

23. The sealant of claim 21, wherein the curing agent is strontium nitrate having a concentration between 25% to 45% by weight.
